(19) United States
(12) Patent Application Publication
(10) Pub. No.: US 2009/0295640 A1
(43) Pub. Date: Dec. 3, 2009

(54) RADIOWAVE DIRECTION DETECTOR AND ANTENNA MOVING DEVICE

(75) Inventor: Takao SHIMIZU, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/347,351

(22) Filed: Dec. 31, 2008

(30) Foreign Application Priority Data
May 30, 2008 (JP) 2008-143710

(51) Int. Cl. G01S 3/02

(52) U.S. Cl. 342/417

(57) ABSTRACT

The radiowave direction detector has a radiowave direction detecting unit detects an arrival direction of the desired radio wave, a converting unit including a plurality of electromagnetic-to-electric converters to convert the desired radio wave, and a computing unit for determining the arrival direction of the radio wave, which matches a preset condition, by comparing the levels of electric signals that are transferred from the converting unit.

### CROSS-REFERENCE TO RELATED APPLICATIONS

This application is based upon and claims the benefit of priority from the prior Japanese Patent Application No. 2008-143710 filed on May 30, 2008, the entire contents of which are incorporated herein by reference.

### FIELD

The present invention relates to a technique for detecting an optimum radiowave reception direction from the level of a received radio wave, and more particularly, to a technique for adjusting the orientation of an antenna based on a detection result.

### BACKGROUND

There is a conventional problem that an antenna of a wireless transmitting/receiving device used for a millimeter wave wireless communication apparatus, a wireless LAN (Local Area Network), a cellular phone, a car-mounted wireless machine, etc. is not efficiently used. Accordingly, the proposals recited in Patent Documents 1 to 3 are made.

According to Patent Document 1, a radiowave direction detecting unit detects and recognizes the arrival direction of a radio wave of a start signal captured by a reception antenna pair at the start of a communication, and an antenna controlling unit causes a signal generating unit to generate response and pilot signals by orientating a directive transmission antenna to the arrival direction of the radiowave, and emits the generated signals. In the meantime, after the start signal is emitted, the reception antenn a pair receives a response signal transmitted from the directive transmission antenna on the other end. Accordingly, the radiowave direction detecting unit can detect the arrival direction, and can orientate the directive transmission antenna to the arrival direction of the radio wave. The direction of the transmission antenna is adjusted by mutually transmitting/receiving the pilot signal during a communication. One of means for emitting the start signal in all directions at the start of a communication moves the radiowave emission direction of the directive transmission antenna. The proposal to cause a communication apparatus of a mobile wireless communication system to prevent unnecessary radio waves, which are generated by an emission in all directions from a transmission antenna and electric field intensities in all directions, from overflowing and disturbing electronic devices, and to prevent a third party from intercepting a communication, and the like by adopting such a configuration is made.

According to Patent Document 2, a CPU determines the reception direction of a wireless radio wave based on the outputs of reception direction detection antennas provided for respective directions of a receiving apparatus itself, and controls an each direction state determination display unit of an each direction state determination display device to display the determined reception direction and reception intensity of the radio wave. The wireless apparatus that can notify a user to which direction the wireless target of a reception antenna of the wireless apparatus is comprehensively set including scattering, reflection, etc. of a radio wave as described above is proposed.

According to Patent Document 3, a feeding probe is arranged to protrude on the side of the top surface of a ground plate by being inserted from the bottom surface of the ground plate toward the side of a reflection plane, which is the top surface. In the vicinity of the feeding probe on the top surface of the ground plate, a semi-cylindrical sub-reflection mirror, which configures a primary emitter along with the feeding probe, is provided, and a main reflection mirror is arranged so that its mirror plane faces the sub-reflection mirror with the feeding probe interposed. The horizontal cross section of the main reflection mirror takes the shape of a parabola, has a predetermined focal point or line, is elevated on the ground plate so that the feeding probe is positioned at the focal point or in the focal line, and installed on the ground plate at a predetermined installation angle θ in order to orientate the elevation angle of the antenna to a radiowave arrival or emission direction. Tracking of an azimuth angle direction of an antenna device is implemented by configuring the ground plate to be rotatable without contacting the feeding probe. The proposal to thin and downsize the antenna used as a car-mounted satellite tracking antenna device, etc. is made by adopting such a configuration.

The above described direction detection implemented with the conventional techniques, however, has a problem that three-dimensional (horizontal and height directions) direction detection is insufficient.

[Patent Document 1] Japanese Laid-open Patent Publication No. 5-206918

[Patent Document 2] Japanese Laid -open Patent Publication No. 2004-156924

[Patent Document 3] Japanese Laid -open Patent Publication No. 2000-082919

### SUMMARY

A radiowave direction detector according to an embodiment of the present invention for use in a wireless communication apparatus that receives a desired radio wave has a radiowave direction detecting unit, a converting unit, and a computing unit. The radiowave direction detecting unit is a unit which takes the shape of a slope from the top portion to each end portion, and in which a plurality of radiowave direction detection tubes, which are holes for detecting an arrival direction of the desired radio wave, are arranged to penetrate from the sloped surface toward the bottom direction at different angles, and a radiowave absorption medium is coated on the inner wall surfaces of the radiowave direction detection tubes. The converting unit has a plurality of electromagnetic-to-electric converters that convert the desired radio wave, which passes through each of the radiowave direction detection tubes, into an electric signal and are provided under the bottom of the radiowave direction detecting unit respectively for the radiowave direction detection tubes. The computing unit determines, as the arrival direction of the radiowave, an angular direction of the radiowave direction detection tube, which matches a preset condition, by comparing the levels of electric signals that are transferred from the converting unit and respectively correspond to the radiowave detection tubes.

Additionally, the radiowave absorption medium is coated on part or the whole of the inner wall surfaces of the radiowave direction detection tubes.

Furthermore, channels are respectively allocated to the radiowave direction detection tubes.

Still further, the orientation of an antenna connected to the wireless communication apparatus is adjusted based on a computation result of the radiowave direction detector.

A radiowave direction detector according to another embodiment of the present invention for use in a wireless communication apparatus that receives a desired radio wave has a radiowave direction detecting unit, a converting unit, and a computing unit.

In the radiowave direction detecting unit, a plurality of loop antennas are provided at different angles. The converting unit has a plurality of electromagnetic-to-electric converters for converting the desired radio wave into an electric signal respectively for the loop antennas. The computing unit determines, as an arrival direction of the radio wave, an angular direction of the loop antenna, which matches a preset condition, by comparing the levels of electric signals that are transferred from the converting unit and respectively correspond to the loop antennas.

Additional objects and advantages of the invention will be set forth in part in the description which follows, and in part will be obvious from the description, or may be learned by practice of the invention. The object and advantages of the invention will be realized and attained by means of the elements and combinations particularly point out in the appended claims.

It is to be understood that both the foregoing general description and the following detailed description are exemplary and explanatory only and are not restrictive of the invention, as claimed.

### BRIEF DESCRIPTION OF THE DRAWINGS

FIG. 1 is top and side views illustrating a structure of a radiowave direction detector according to a first embodiment;

FIG. 2 is cross-sectional and enlarged views illustrating the structure of the radiowave direction detector according to the first embodiment;

FIG. 3 is a block diagram illustrating the configuration of the radiowave direction detector according to the first embodiment;

FIG. 4A represents data and a table, which are recorded to a table;

FIG. 4B represents data and a table, which are recorded to a table;

FIG. 4C illustrates a correspondence between a radiowave detection sensor and a table;

FIG. 4D illustrates a relationship between horizontal angle data and height angle data;

FIG. 5 is a block diagram illustrating a configuration for controlling an antenna moving device by using a radiowave direction detector according to a second embodiment;

FIG. 6A illustrates the movements of an antenna when a horizontal angle is adjusted;

FIG. 6B illustrates the movements of the antenna when a height angle is adjusted;

FIG. 7 is a schematic diagram representing data used to calculate the amount of motor driving;

FIG. 8 is top and side views illustrates a structure of a radiowave direction detector according to a third embodiment; and

FIG. 9A represents the arrival of a radio wave; and

FIG. 9B represents data and a process, which are used to detect a radiowave direction.

### DESCRIPTION OF THE PREFERRED EMBODIMENTS

Embodiments according to the present invention are described in detail below with reference to the drawings.

### First Embodiment

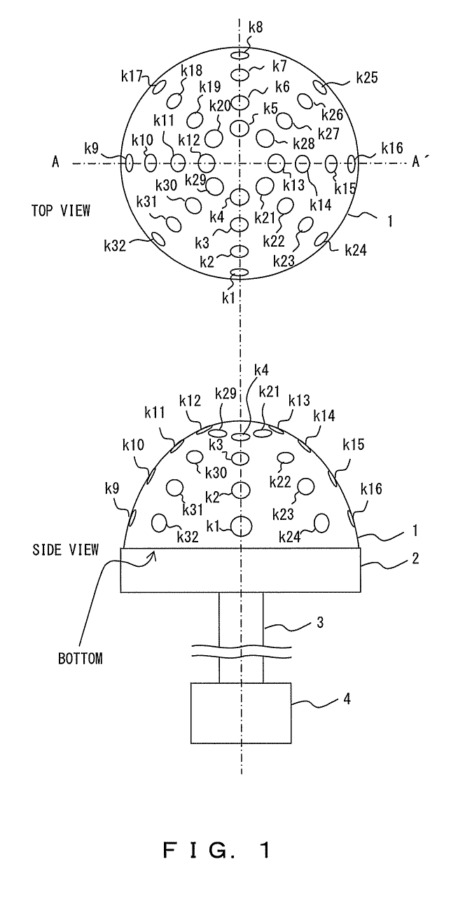

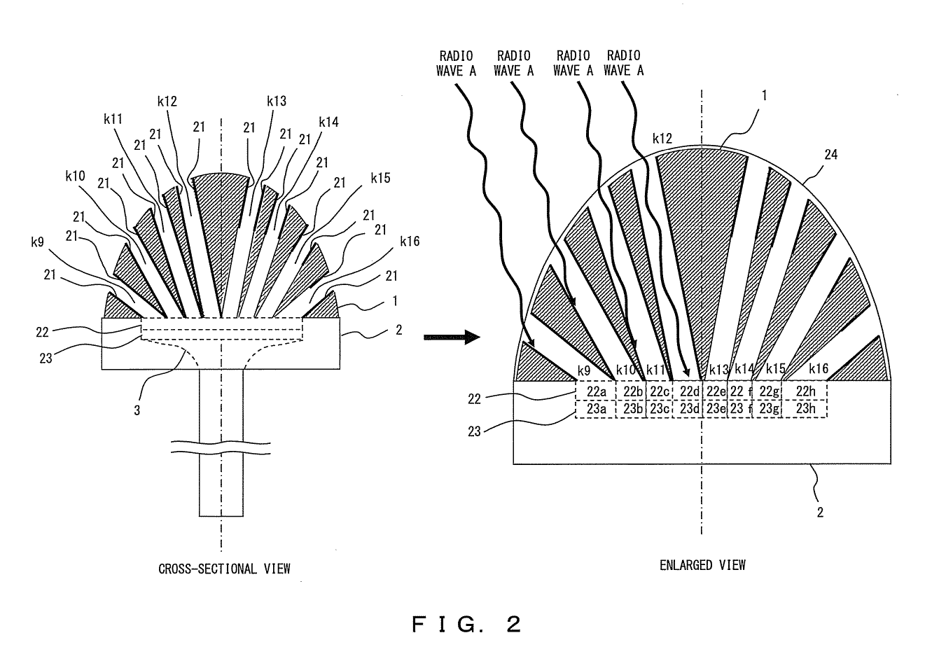

FIG. 1 is top and side views illustrating a structure of a radiowave direction detector. The radiowave direction detector, which is composed of a radiowave direction detecting unit 1, a converting unit 2, a connecting unit 3 and a controlling unit 4, is used for a wireless communication apparatus. The radiowave direction detecting unit 1 takes the shape of a slope from the top portion toward each end portion. Desirably, the shape of the radiowave direction detecting unit 1 is, for example, hemispherical or semi-elliptical. As its material, a metal, synthetic resin, etc. may be used. However, it is desirable that the material does not transmit or absorb radio waves. Additionally, a plurality of radiowave direction detection tubes k1 to k32, which are holes for detecting the arrival direction of a desired radio wave, are arranged to penetrate from the sloped surface of the radiowave direction detecting unit 1 toward the bottom surface direction at different suitable angles and with a suitable density. Desirably, the shape of the holes of the radiowave direction detection tubes k1 to k32 is, for example, circular, and the size of the holes is 10 times or more of a wavelength. Moreover, a radiowave absorption medium 21 (see FIG. 2) is coated on the inner wall surfaces of the radiowave direction detection tubes k1 to k32. The shape of the hole is not required to be circular, and may be of a diameter through which a desired radio wave can pass. However, tubes are desirably used for electromagnetic waves of millimeters or shorter in order to make the detector compact in size.

The converting unit 2 receives a desired radio wave that passes through any of the radiowave direction detection tubes k1 to k32, and converts the received radio wave into an electric signal. The converting unit 2 includes, for example, pluralities of antennas, CMOS (Complementary Metal Oxide Semiconductor) devices for detecting an electromagnetic wave, CCDs (Charge Coupled Devices) for detecting an electromagnetic wave, which are provided under the bottom of the radiowave direction detecting unit 1 respectively for the radiowave direction detection tubes k1 to k32. When a radio wave is received by an antenna, an electromagnetic wave may be converted into an electric signal after being transferred to the converting unit 2 with a waveguide tube, etc. If a plurality of devices having a small planar antenna, or CMOS devices or CCDs for detecting an electromagnetic wave are used, the devices themselves can be used as the converting unit 2.

The connecting unit 3 is a cable for transferring the electric signal, which is an output from the converting unit 2, to the computing unit 4.

The computing unit 4 selects any of the radiowave direction detection tubes k1 to k32, which matches a preset condition, by comparing the levels of electric signals that are transferred from the converting unit 2 and respectively correspond to the radiowave direction detection tubes k1 to k3, and determines the angular direction corresponding to the selected one of the radiowave direction detection tubes k1 to k32 to be the arrival direction of the radio wave.

FIG. 2 is cross-sectional and enlarged views of the radiowave direction detector illustrated as FIG. 1 when taken along a line A-A′. A method for detecting a radiowave arrival direction with the radiowave direction detection tubes k1 to k32 is described with reference to the cross-sectional and enlarged views of FIG. 2. In the radiowave direction detection tubes k9 to k16 illustrated as FIG. 2, a radiowave detection sensor 22 (antenna, a CMOS device for detecting an electromagnetic wave, a CCD for detecting an electromagnetic wave), which is provided in the converting unit 2 and corresponds to each of the radiowave direction detection tubes k9 to k16, transmits only a radio wave that arrives in a desired direction. In the case illustrated as FIG. 2, radiowave detection sensors 22a to 22h are provided respectively for the radiowave direction detection tubes k9 to k16. Filter units 23a to 23h are respectively provided for the radiowave detection sensors 22a to 22h.

Additionally, the radiowave absorption medium 21 is coated on the inner side walls of the radiowave direction detection tubes k9 to k16. The radiowave absorption medium 21 may be coated, for example, on the entire inner wall surfaces like the radiowave direction detection tubes k9 to k12, or may be coated on the entrance of a radio wave on an inner wall surface to the middle of the tube like the radiowave direction detection tubes k3 to k16. There is no need to coat the medium on the entire inner wall surfaces of the tubes. It is sufficient to coat the medium on one half or less of each tube. As described above, the radiowave absorption medium 21 is provided to attenuate radio waves other than a radio wave that proceeds straight along a hole if the desired radio wave arrives in a direction different from the desired arrival direction. The radiowave absorption medium 21 is not always required to be coated although an attenuation rate drops.

When a radio wave A enters the radiowave direction detection tubes k9 to k16 as illustrated as the enlarged view of FIG. 2, it is detected by the radiowave detection sensor 22d without being attenuated by the radiowave direction detection tube k12, filtered by the filtering unit 23d, and the gain of the radio wave A is detected. In the meantime, when the radio wave A enters the radiowave direction detection tubes k9, k10, k11, k13, k14, k15 and k16 other than the radiowave direction detection tube k12, it is absorbed by the radiowave absorption medium 21 and significantly attenuated.

The filter units 23 execute a filtering process for frequencies other than a desired band when the radiowave received by the radiowave detection sensors 22 is converted into an electric signal, and transfers the electric signal, for which the filtering process is executed, to the computing unit 4. Here, the filter units 23 may be provided respectively for the radiowave detection sensors 22, or one filter unit 23 may be provided for the plurality of radiowave detection sensors 22, and may execute the filtering process respectively for the radiowave detection sensors 22 in a time-division manner.

Then, the output signals of the filter units 23a to 23h are transferred to the computing unit 4, which in turn determines the arrival direction of a radio wave based on each of the output signals.

Desirably, the radiowave direction detection tubes k1 to k32 are covered with a non-conductive sheet 24, etc. in order to keep dust out. Although the sheet 24 covers the entire surface of the radiowave direction detector in the enlarged view of FIG. 2, a non-conductive transparent sheet 24 may be provided respectively for the holes. It is desirable to use a non-conductive transparent sheet if a visible light is detected.

Furthermore, there is no need to insert the radiowave direction detection tubes k1 to k32 straight up to the radiowave detection sensors 22. The radiowave direction detection tubes k1 to k32 may be provided with a reflection plate or mirror at a bending or folded portion even in the shape of a curve or a folded line as far as they can guide an electromagnetic wave to the radiowave detection sensors 22.

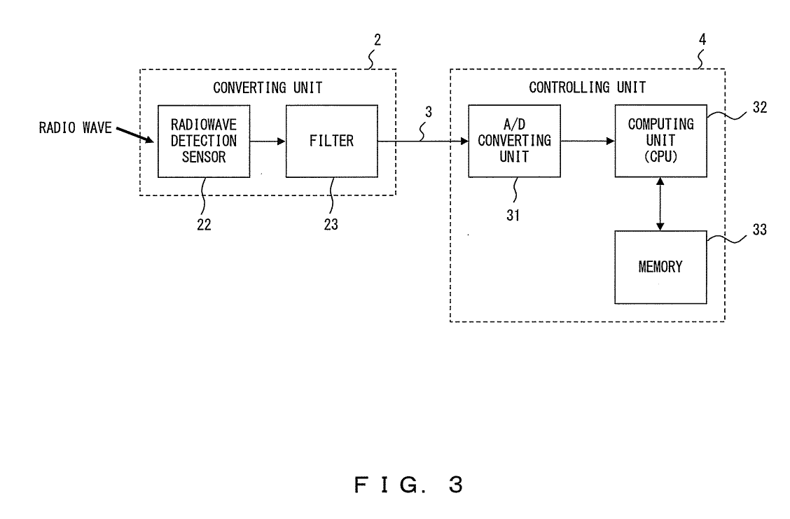

Configurations of the converting unit 2 and the controlling unit 4 are represented as FIG. 3. The output signal from the converting unit 2 is transferred to the controlling unit 4 via the connecting unit 3. In the configuration represented as FIG. 3, the transferred output signal is A/D converted, and computed by a CPU, etc., so that the arrival direction of the radio wave is determined.

The A/D converting unit 31 converts the output signals of the filter units 23, which respectively correspond to the radiowave direction detection tubes k1 to k32, into digital signals, and transfers the converted signals to the computing unit 32 at a succeeding stage.

The computing unit 32 compares the output signals of the filter units 23, which respectively correspond to the radiowave direction detection tubes k1 to k32, and determines the arrival direction of the radiowave based on the results of the comparison.

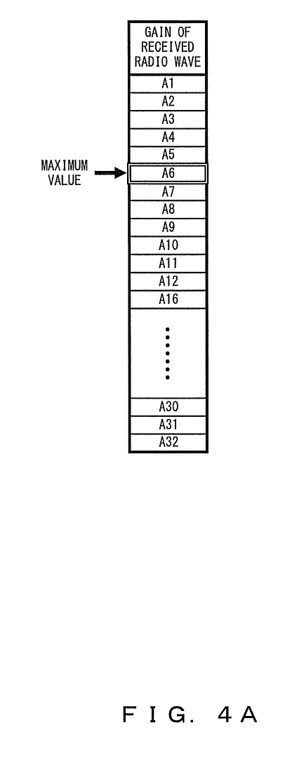

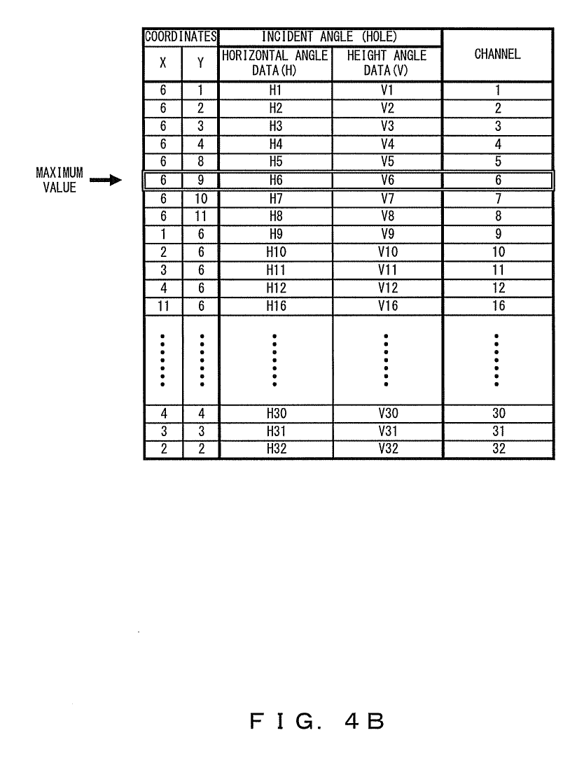

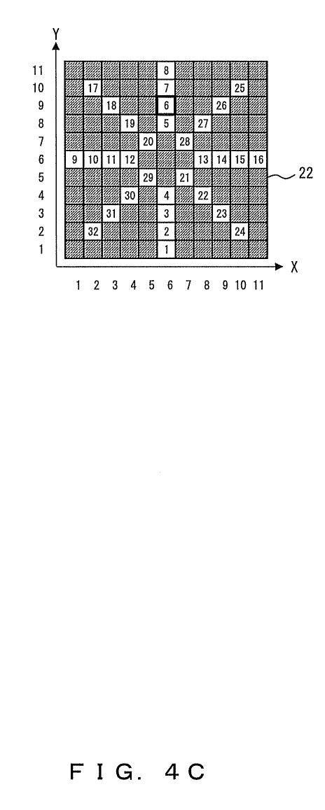

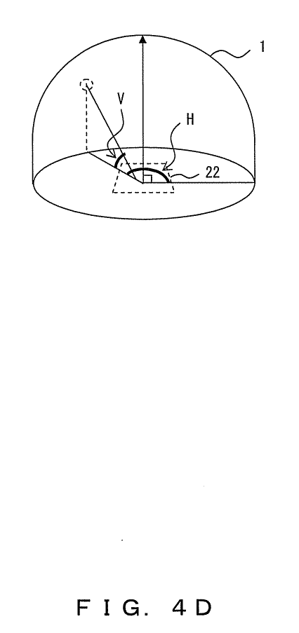

To the memory, measured data, a table, which are illustrated as FIG. 4, and the like are recorded.

In FIG. 3, the computation is performed with the digital process. For example, the maximum level of the output signal levels maybe detected by using a comparator, etc. without making an A/D conversion, and the angle at which the radiowave direction detection tube, which corresponds to the maximum output signal, may be determined as a radiowave arrival direction.

Gains A1 to A32 of received radio wave, which respectively correspond to the radiowave direction detection tubes k1 to k32, are recorded to the memory 33 (see FIG. 4A). The gains are calculated with the computation, for example, from electric signals obtained by the computing unit 32. Desirably, the gains A1 to A32 are calculated by obtaining the electric signals for a predetermined duration and by using their average value.

Next, the maximum value of the gains A1 to A3, which respectively correspond to the radiowave direction detection tubes k1 to 32, is detected (see FIG. 4A). In FIG. 4A, the maximum value A6 is assumed to be detected. The maximum value of the gains is detected as a condition in this embodiment. However, an accumulated maximum value of gains A1 to A32, which are accumulated for a predetermined duration and compared, may be detected.

Then, coordinates (an incident angle (H6,V6) corresponding to the coordinates (6,9) in FIG. 4B) in the table, which corresponds to the detected comparison result (A6 in FIG. 4A), is selected. Here, the coordinates represent the position of each of the radiowave detection sensors 22 (1 to 32) that are arranged respectively for the radiowave direction detection tubes k1 to k32 as represented as FIG. 4C. The incident angle indicates the incident angle of a radio wave detected by each of the radiowave detection sensors 22 (1 to 32), and is represented by a height angle V and a horizontal angle H, which are illustrated as FIG. 4D.

Additionally, channels may be allocated to the radiowave direction detection tubes k1 to k32, and a wireless communication may be made by switching the channels. Channels may be also allocated to respective directions.

With the above described configuration, the direction of a wireless terminal can be determined by measuring the intensity of a radio wave with the tubes that are structured as hemispherical compound eyes and respectively arranged for radiowave directions.

Additionally, the gain can be improved since the directive antenna can be effectively used by detecting a direction.

Furthermore, the performances of a wireless small base station, a car-mounted wireless terminal, a wireless terminal, a small base station of electromagnetic waves of millimeter waves or shorter (including a visible light) can be improved. Also the performances of a small base station, and a ground-/floor-buried small base station can be improved.

Still further, a communication is made in each direction by detecting the direction of a wireless terminal, whereby influences such as reductions in wireless power consumption, a multi-path can be eliminated.

### Second Embodiment

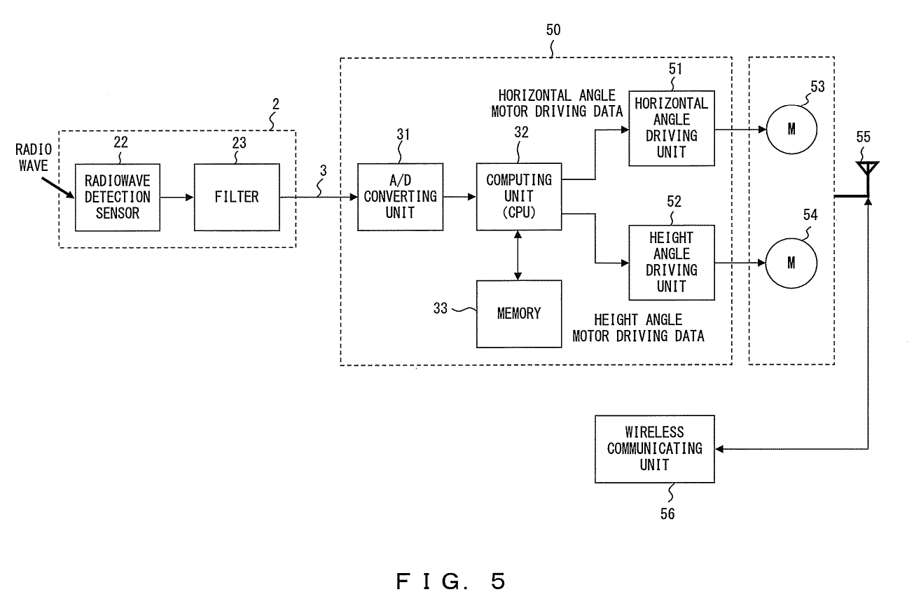

FIG. 5 is a block diagram illustrating a configuration for adjusting the orientation of an antenna having a moving mechanism to a radiowave arrival direction by using data calculated by the radiowave direction detector described in the first embodiment.

A controlling unit 50 further has a horizontal angle driving unit 51 and a height angle driving unit 52 in addition to the controlling unit 4 described in the first embodiment, and controls motors 53 and 54 for adjusting the orientation of the antenna 55.

The horizontal angle driving unit 51 calculates horizontal angle motor driving data for controlling the motor 53 based on horizontal angle data obtained by the computing unit 32. The height angle driving unit 52 calculates height angle motor driving data for controlling the motor 54 based on height angle data obtained by the computing unit 32. The motors 53 and 54 are controlled, for example, with a PWM (Pulse Width Modulation) control, etc. Namely, a rotational speed, the amount of rotation, etc. are controlled with a generated PWM signal.

The motor 53 drives the antenna 55 until the antenna 55 forms the angle indicated by the horizontal angle data, and stops when the angle indicated by the horizontal angle data is formed. The motor 54 drives the antenna 55 until the antenna 55 forms the angle indicated by the height angle data, and stops when the angle indicated by the height angle data is formed.

A wireless communicating unit 56 is, for example, a wireless base station, a car-mounted wireless terminal, a wireless terminal, etc.

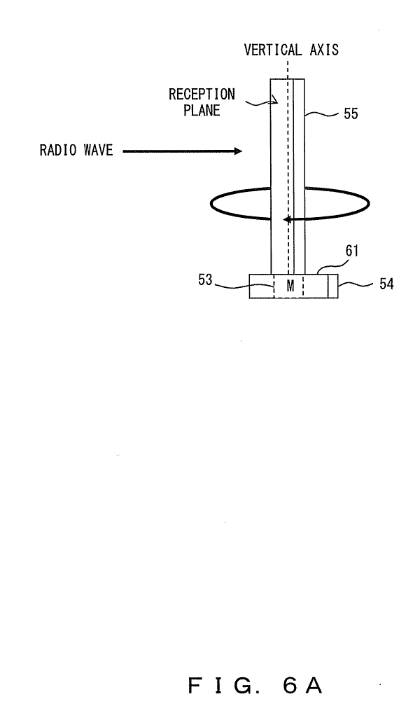

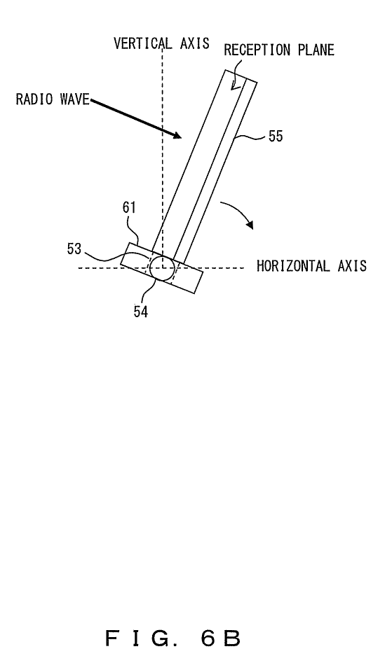

FIG. 6 is a schematic diagram illustrating the operations of the moving mechanism. The antenna 55 illustrated in FIG. 6 has a structure that can receive only a directive radio wave or a radio wave in a predetermined direction. An antenna moving device 61 is attached to the bottom of such an antenna 55. The motors 53 and 54 are provided in the antenna moving device 61.

In FIG. 6A, the motor 53 rotates the antenna 55 with respect to the vertical axis until the reception plane of the antenna 55 forms an angle indicated by the horizontal angle data. For example, the rotational axis of the motor 53 rotates an axis that is provided nearly vertical to the vertical axis of FIG. 6A to adjust the horizontal angle (H).

In FIG. 6B, the motor 54 rotates the antenna 55 with respect to the horizontal axis until the reception plane of the antenna 55 forms an angle indicated by the height angle data. For example, the rotational axis of the motor 54 rotates an axis that is provided nearly vertical to the horizontal axis of FIG. 6B to adjust the height angle (V).

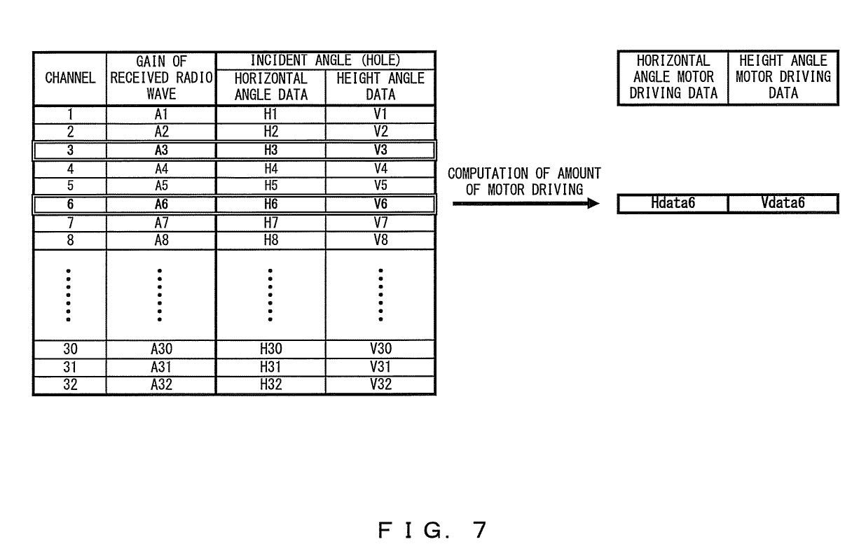

The table represented as FIG. 7 is recorded to the memory 33 in a similar manner as in the first embodiment, and the computing unit 32 calculates horizontal angle motor driving data and height angle motor driving data respectively from the horizontal angle data and the height angle data. The horizontal angle motor driving data and the height angle motor driving data are data intended to drive the motors 53 and 54. When the current orientation of the antenna is adjusted to its new orientation in the shortest time, the amounts of motor driving of the motors 53 and 54 are calculated by using the current horizontal angle data and height angle data of the antenna 55, and horizontal angle data and height angle data of the new orientation of the antenna 55. For example, if the horizontal angle data H3, the height angle data V3, and the new radiowave arrival direction correspond to the channel 6 when the current orientation of the antenna is the horizontal angle data H3 and the height angle data V3 in the table represented as FIG. 7, horizontal angle motor driving data H data 6, and height angle motor driving data V data 6 are generated based on the horizontal angle data H6 and the height angle data V6.

As another method, the antenna 55 may be adjusted to a new radiowave arrival direction after the current orientation of the antenna 55 is once restored to the reference orientation of the antenna 55, which is indicated by the horizontal angle data and the height angle data. The antenna may be a parabolic antenna, a loop antenna, a Yagi antenna, etc. other than the rod antenna illustrated as FIG. 6.

By adjusting the orientation of the antenna having the moving mechanism to a radiowave arrival direction in this way, a wireless communication can be made with an optimum orientation.

Additionally, the performances of a wireless small base station, a car-mounted wireless terminal, a wireless terminal, a small base station of electromagnetic waves of millimeter waves or shorter (including a visible light) can be improved. Also the performances of a small base station, a small base station of a ground-/floor-buried type can be improved.

### Third Embodiment

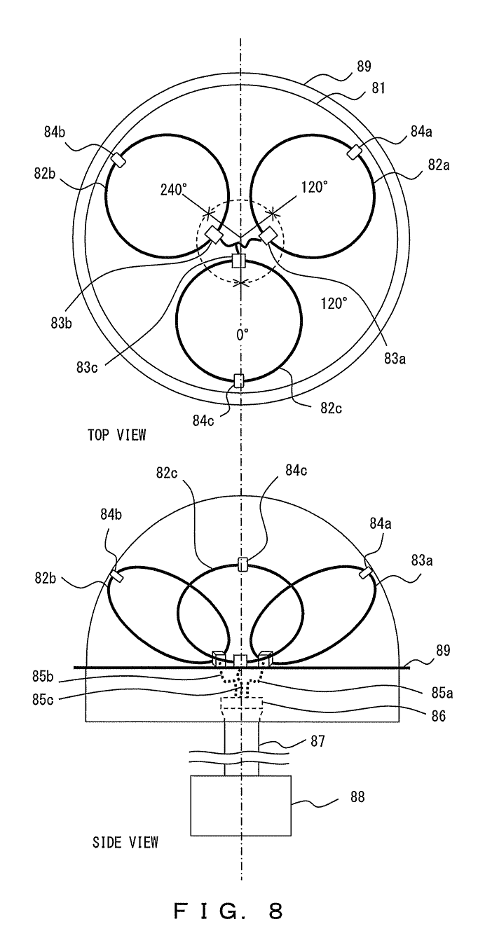

FIG. 8 is top and side views illustrating the structure of a radiowave direction detector for detecting the arrival direction of a radio wave of millimeter waves or longer. In the example illustrated as FIG. 8, three loop antennas are arranged to be able to receive radio waves in mutually different directions. For example, in the case of a loop antenna for identifying the arrival direction of an electromagnetic wave (radio wave, etc.) having a frequency of 2.5 GHz (wavelength λ=12 cm), a radius r results in approximately 20 mm (the diameter is 40 mm). This is because the length of the loop is equivalent to the wavelength λ(λ=2 πr). The radius r of the loop antennas 82a to 82c is assumed to be 20 mm, and the loop antennas 82a to 82c are arranged to orientate in the directions of 0°, 120°, and 240°. This embodiment refers to the case where the three loop antennas are used. However, three or more loop antennas may be used.

Additionally, a radiowave shield/absorption plate 89 must be implemented as an electromagnetic wave absorption medium when a height direction is determined. When the radiowave direction detector is mounted on an airplane, whether a radio wave arrives either upward or downward cannot be determined. Therefore, two radiowave shield/absorption plates 89 for upward and downward directions are required.

Furthermore, the loop antennas 82a to 82c are secured to a body (such as a hemispherical body) by providing fixtures 84a to 84c on the body, and their angles with respect to the horizontal plane are determined. Desirably, the horizontal angle of the antennas is 45°.

For radio waves received by the loop antennas 82a to 82c, their electric signals converted by converters 83a to 83c are transferred to filter units 86 via cables 85a to 85c.

The filter units 86 execute a filtering process for the electric signals, and transfer an electric signal having a desired frequency band to a computing unit 88 via a connecting unit 87 similar to the filter units 23 described in the first embodiment.

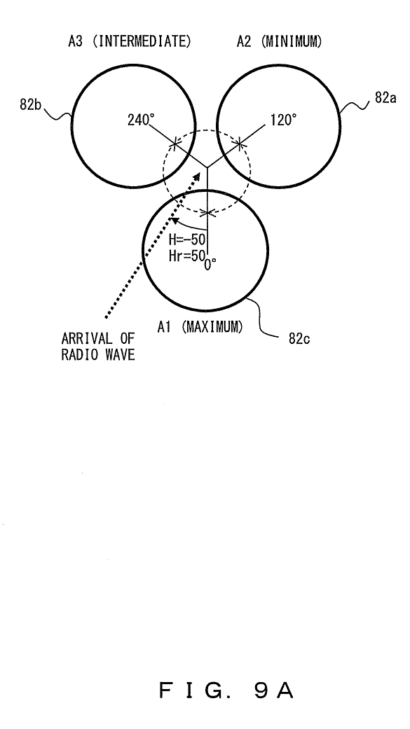

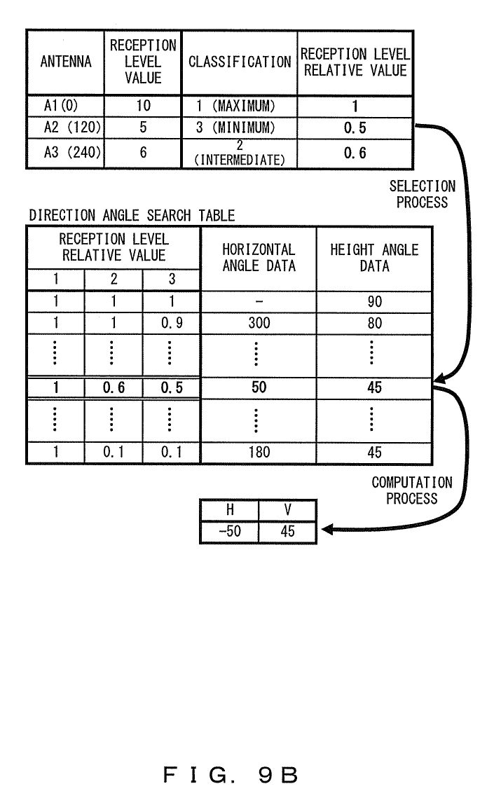

The computing unit 88 has the same function as the computing unit described in the first embodiment. The computing unit 88 is described with reference to FIG. 3. To the memory 33, measured data, a table, which are represented as FIG. 9B, and the like are recorded. Gains of the received radio waves, which respectively correspond to the loop antennas 82a to 82c, are recorded to the memory 33 (see FIG. 9). For example, the gains (reception levels) are calculated from electric signals obtained by the computing unit 32 with a computation. Desirably, the gains are calculated by obtaining the electric signals for a predetermined duration and by using their average value.

Next, a relative value is calculated by obtaining a correlation among the gains that respectively correspond to the loop antennas 82a to 82c, a comparison is made between the relative value and preset relative values in a direction angle search table, which are measured with theoretical calculations and experiments, the preset relative value closest to the measured relative value is selected, and the angles (horizontal angle, height angle) corresponding to the preset relative value are selected, whereby a radiowave arrival direction is determined.

FIG. 9A is a schematic diagram representing the arrival of a radio wave (indicated by a broken line arrow). FIG. 9B is a schematic diagram representing a process for detecting the arrival direction of the radio wave represented as FIG. 9A.

If the reception levels of the radio wave received by the loop antennas 82a to 82c when the radio wave arrives in the direction represented as FIG. 9A are levels 10, 5 and 6 respectively for the loop antennas 82c (A1), 82a (A2), and 82b (A3), the computing unit 32 classifies the loop antennas 82c, 82b and 82a as a reference antenna (the antenna that receives the maximum value: 1), an intermediate antenna (2), and a minimum antenna (3) respectively. Thereafter, reception level correlation values (such as a ratio of each reception level to a maximum reception level) are calculated from the reception level values of the loop antennas 82a to 82c. In this embodiment, the ratio is calculated based on the reference antenna and the antennas on both sides of the reference antenna. However, a plurality of antennas may be used.

Additionally, the horizontal angle data Hr represented as FIGS. 9A and 9B indicates the horizontal angle measured from the reference antenna (the antenna that receives the maximum value) toward the intermediate antenna 82b (A3). The height angle data V indicates the angle (elevation angle) in the height direction.

Operations of the radiowave direction detector are described.

Initially, the reception levels of the loop antennas 82a to 82c are measured as a process 1 (see FIG. 9B).

Next, the loop antennas 82a to 82c are classified in ascending order of the measured reception levels are classified as 1 to 3 in ascending order of the measured reception levels of the loop antennas 82a to 82c as a process 2. For example, values relative to the maximum value 1 of the reception levels are respectively created.

Then, direction angles (horizontal angle data, height angle data (Hr,V)) are obtained from the closest combination of relative values from a direction search table that is created beforehand and represented as FIG. 9B as a process 3. In the examples represented as FIGS. 9A and 9B, (1.0, 0.6, 0.5) is detected, and the horizontal angle data and the height data result in (50,45).

Thereafter, the final direction angle (H,V) is calculated with a process 4. Since the above described Hr is the angle relative to the antenna from which the maximum value is detected, the final radiowave arrival direction must be calculated. For example, a correction is made to obtain the final direction angle (H,V) by assuming the loop antenna 82c to be 0°. In the examples represented as FIGS. 9A and 9B, the horizontal angle data and the height angle data (−50,45) are calculated. −50 is a value calculated with the angle measured counterclockwise in the figure by assuming the center of the loop antenna 82c to be 0°.

The reception level becomes maximum when a radiowave direction and the surface of the loop antenna are parallel, and becomes zero when the radiowave direction and the surface are vertical. With the above described configuration, a radiowave arrival direction can be detected by preparing a plurality of loop antennas even for millimeter waves or longer, and by measuring reception radiowave levels. It is sufficient to prepare at least three loop antennas.

Additionally, a direction angle at a transmission source can be three-dimensionally identified according to the reception level of an antenna. Moreover, since a hemispherical direction angle can be detected with the above described single apparatus, a direction angle of the entire sphere can be accurately detected by using two apparatuses.

However, the detection can be possibly affected by diffraction in the case of a long wavelength even if two apparatuses are used. Therefore, the reception levels of upper and lower hemispheres are compared to select a higher level. Moreover, a direction can be detected for radio waves of a plurality of wavelengths by preparing loop antennas, the length of which is changed, by the number of wavelengths.

Since a loop antenna does not have forward and backward directivities, two apparatuses are required to cover all the three-dimensional directions as described above. However, only one apparatus may be sufficient if three antennas having forward and backward directivities are used.

Additionally, the radiowave direction detector can be combined with the antenna moving device described in the second embodiment.

The present invention is not limited to the above described embodiments, and various improvements and modifications can be made within a scope that does not depart from the gist of the present invention.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor dose the organization of such examples in the specification relate to a showing of the superiority and inferiority of the invention. Although the embodiment(s) of the present invention(s) has (have) been described in detail, it should be understood that the various changes, substitutions, and alterations could be made hereto without departing from the spirit and scope of the invention.

1. A radiowave direction detector for use in a wireless communication apparatus that receives a desired radio wave, comprising:
a radiowave direction detecting unit which takes a shape of a slope from a top portion to each end portion, and in which a plurality of radiowave direction detection tubes, which are holes for detecting an arrival direction of the desired radio wave, are arranged to penetrate from a sloped surface toward a bottom direction at different angles, and a radiowave absorption medium is coated on inner wall surfaces of the radiowave direction detection tubes;
a converting unit comprising a plurality of electromagnetic-to-electric converters that convert the desired radio wave, which passes through each of the radiowave direction detection tubes, into an electric signal and are provided under a bottom of the radiowave direction detecting unit respectively for the radiowave direction detection tubes; and
a computing unit for determining, as an arrival direction of the radio wave, an angular direction of the radiowave direction detection tube, which matches a preset condition, by comparing levels of electric signals that are transferred from the converting unit and respectively correspond to the radiowave detection tubes.

2. The radiowave direction detector according to claim 1, wherein the radiowave absorption medium is coated on part or a whole of the inner wall surfaces of the radiowave direction detection tubes.

3. The radiowave direction detector according to claim 2, wherein channels are respectively allocated to the radiowave direction detection tubes.

4. An antenna moving device for adjusting an orientation of an antenna connected to the wireless communication apparatus based on a computation result of the radiowave direction detector according to claim 1.

5. A radiowave direction detector for use in a wireless communication apparatus that receives a desired radio wave, comprising:
a radiowave direction detecting unit in which a plurality of loop antennas are provided at different angles;
a converting unit comprising a plurality of electromagnetic-to-electric converters for converting the desired radio wave into an electric signal respectively for the loop antennas; and
a computing unit for determining, as an arrival direction of the radio wave, an angular direction of the loop antenna, which matches a preset condition, by comparing levels of electric signals that are transferred from the converting unit and respectively correspond to the loop antennas.

6. The radiowave direction detector according to claim 5, wherein:
the computing unit recognizes a maximum level among the levels of the electric signals respectively measured for the loop antennas as a reference level, and calculates a relative value based on the reference level and a reception level of the loop antenna at a position determined with reference to the loop antenna that receives the reference level;
a preset relative value closest to the relative value is selected by comparing the relative value and preset relative values provided to select the arrival direction of the radio wave; and
preset angle data corresponding to the selected preset relative value is selected.

7. The radiowave direction detector according to claim 2, wherein the computing unit determines, as an arrival direction of the radio wave, an angular direction of the radiowave direction detection tube that detects a maximum level among the levels of electric signals detected by the radiowave direction detection tubes.

8. The radiowave direction detector according to claim 6, wherein channels are respectively allocated to the radiowave direction detection tubes.

9. An antenna moving device for adjusting an orientation of an antenna connected to the wireless communication apparatus based on a computation result of the radiowave direction detector according to claim 5.
